(19) United States
(12) Patent Application Publication
(10) Pub. No.: US 2009/0000648 A1
(43) Pub. Date: Jan. 1, 2009

(54) Method and device for preparing a medical instrument

(76) Inventor: Daniel Schaffarzick, Elsbethen (AT)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/008,844

(22) Filed: Jan. 15, 2008

(30) Foreign Application Priority Data
Jan. 16, 2007 (EP) 07000808.1

(51) Int. Cl. B08B 3/08; B08B 13/00

(52) U.S. Cl. 134/28; 134/30; 134/26; 134/95.1

(57) ABSTRACT

The present invention relates to a method for preparing a medical instrument, in particular a handpiece, with the method involving the following steps: pre-rinsing the instrument with a pre-rinsing liquid whose temperature is below the coagulation temperature of protein; rinsing the instrument with a liquid mixture that comprises water and an enzymatic cleaning agent, wherein the liquid mixture comprises a temperature of 40° C. to 70° C.; disinfecting the instrument with a liquid mixture that comprises water and an oxidant, wherein the liquid mixture has a minimum temperature of 50° C. The invention further relates to a device for implementing such a method.

The invention relates to a method and a device for preparing medical, in particular dental-medical, and surgical instruments, in particular handpieces.

Instruments and/or handpieces should be cleaned after each use, both for reasons of hygiene and in order to prevent any transmission of germs, pathogenic micro-organisms, blood, etc. between patients, and furthermore for technical reasons, because particles, for example tissue particles, in particular bone material, and liquids, for example treatment liquids for cooling the preparation location or bodily fluids from the patient, can enter instruments or handpieces during treatment, and within the instruments or handpieces can damage components, for example bearings etc., or can impede the function of such components. Cleaning of the instruments also serves to remove old lubricant material on which, in particular, impurities can lodge.

It is an object of the present invention to provide an improved method and a corresponding device for implementing such a method.

This object is solved by a method according to claim 1 and a method according to claim 6, as well as by a device according to claim 20. Claims 2 to 5 and 7 to 19 relate to particularly advantageous embodiments of the methods according to claims 1 and 6; claims 21 to 24 relate to particularly advantageous embodiments of the device according to claim 20.

According to the invention, the method for preparing one or several medical instruments comprises the following steps:
A) pre-rinsing the instrument with a pre-rinsing liquid whose temperature is below the coagulation temperature of protein;
B) rinsing the instrument with a liquid mixture that comprises water and an enzymatic cleaning agent, wherein the liquid mixture has a temperature of 40° C. to 70° C.;

The present invention, generally speaking, relates to a method and a device for preparing a medical instrument, wherein said invention primarily relates to handpieces or contra-angle handpieces, however, any other medical instruments can be prepared. The following description thus always relates to handpieces or contra-angle handpieces in the narrower sense, as well as to medical instruments in the wider sense, without any limiting effect, although for the sake of simplification the text explicitly only refers to a handpiece.

In all the steps of the method according to the invention the liquids are preferably fed in a continuous-flow process through the handpiece or through several handpieces (or an instrument), which if need be can be used at the same time in a corresponding cleaning device.

The combination of the method-related steps A, B and C in this order and under the defined conditions returns exceptionally good results, wherein the inventors have found that the outstanding results are not just due to the cumulative results of the individual steps, but instead that a special combinatorial effect results, in particular in view of the method-related steps B and C, namely rinsing the instrument with an enzymatic cleaning agent in conjunction with subsequent disinfecting of the handpiece with the use of an oxidant.

Step A, pre-rinsing of the instrument, ensures that coarse dirt particles and impurities are cleaned from the instrument, wherein a maximum temperature is selected that ensures that any coagulation of proteins, which coagulation would make cleaning more difficult, is prevented. Preferably, a maximum temperature of 42° C. is selected; in a particular method a maximum temperature of 40° C. is set.

The subsequent step, supplementing the aforesaid, of rinsing the instrument or handpiece with a liquid mixture that comprises water and an enzymatic cleaning agent, firstly represents a very effective cleaning step by means of which in a short time very good results are achieved, and in particular many impurities can be removed from the surfaces of the handpiece. In the context of this invention, the term “cleaning” refers to the removement, the so-called depletion, of existing impurities, in particular of organic material including micro-organisms, wherein in step B according to this invention both a mechanical effect is achieved by the liquid mixture itself, and a chemical or biochemical effect as a result of the added enzymatic cleaning agent, coupled with a thermal effect by heating the liquid mixture to 40° C. to 70° C. The cleaning performance that is achieved in one cleaning step can be verified with test models that are, for example, described in the standard EN ISO 15883-1.

Secondly, the inventors have found that it is precisely the rinsing of the instrument or of the handpiece with a liquid mixture that comprises an enzymatic cleaning agent that causes “conditioning” for the subsequent step of disinfecting by means of an oxidant, so that an overall result is made possible that exceeds the expected “sum” of the results of the individual steps. The combinatorial effect caused by such “conditioning” by the enzymatic cleaning agent in conjunction with the oxidant used for disinfection, thus leads to significantly better results than would be the case if another cleaning agent or another disinfectant had been used.

The inventors have found that in alternative cleaning in step B without an enzymatic cleaning agent but with otherwise unchanged method-related steps, disinfection of the handpieces leads to poorer results, i.e. to a higher residual number of germs, even if the cleaning result or the cleaning performance according to step B is held at the same level, which can, for example, be verified with the use of the above-mentioned test models according to EN ISO 15883-1. Likewise, a poorer overall result is achieved if step C according to the invention were to be replaced by some other disinfection step, for example by disinfection by means of thermal treatment.

It is thus not merely the individual method-related steps seen in isolation that are decisive in achieving the surprisingly high efficiency of the method according to the invention, but instead the combination of these method steps, wherein it is in particular the “conditioning” described above, which is achieved by step B and by the use of the enzymatic cleaning agent, that is of outstanding importance for the disinfection step C that uses an oxidant.

According to the invention, the liquids are fed in a continuous-flow process onto or through the instrument, in particular through the handpiece, which is associated with an advantage in that the instruments do not have to remain in a liquid bath for an extended period of time, so that a situation is prevented in which, for example, already dislodged dirt build-up would lodge anew at some other location on the instrument. Furthermore, this approach ensures that in each case the cleaning liquids are supplied fresh because there is no circulation whatever in which already used liquids would be used anew.

The individual steps of the method according to the invention can be provided both during interior cleaning and during exterior cleaning of the handpiece. Particularly preferably the handpiece is subjected to both interior cleaning and exterior cleaning, wherein such cleaning can take place either concurrently or consecutively.

Furthermore it is possible to provide a method and a corresponding device in which in each case an individual handpiece is cleaned; however, it is also possible to provide a method and an associated device in which several handpieces can be cleaned at the same time.

In a preferred method, in step A only water is used as a pre-rinsing liquid, wherein this water can be directly fed to the handpiece, for example, from a line; it can thus essentially have a temperature of tap water, wherein the tap water is not additionally heated. Typical temperatures of the water in such a method are approximately 15° C. to 20° C. This provides an advantage in that on the one hand the temperature of the pre-rinsing liquid is clearly below the coagulation temperature of the proteins, and on the other hand no additional heating energy is required, so that the method is economical to implement.

It should be pointed out that water, for example tap water, can comprise automatic additives, for example chlorine or fluorine. However, any reference in this description to water being used “without additives” means that no additives of any sort, for example cleaning agents or oxidants, are added within the framework of the cleaning method or in the cleaning device.

In another embodiment it is, however, also possible for the pre-rinsing liquid to comprise both water and a cleaning agent, preferably also in this step already an enzymatic cleaning agent, wherein, however, at least in the pre-rinsing step A other cleaning agents can also be used. In particular, detergents that facilitate this pre-rinsing process are cleaning agents that are suitable for use in the pre-rinsing process. They reduce, in particular, the interfacial tension of the surface to be cleaned, of the impurities and of the solvent, in the present case water. In particular, the use of naturally occurring or synthetically produced tensides or emulgators and wetting agents is recommended.

The liquid mixture that in step B is used when rinsing the handpiece comprises water and contains at least one enzyme group, wherein preferably proteases are used. Particularly preferably, several enzyme groups, in particular proteases and lipases, are used, wherein in another preferred method amylases are also used, either in addition or instead of the above-mentioned enzyme groups. These enzyme groups have been shown to be particularly effective and not only ensure an outstanding cleaning result, but also lead to good conditioning for the subsequent disinfection step.

In a preferred method, the concentration of the cleaning agent is between 0.1% and 2%, in particular 0.1% to 1%, in particular between 0.3% and 0.7%, wherein it has been found that an optimum concentration is approximately 0.5%.

Preferably, apart from the cleaning agent, the liquid mixture for rinsing the handpiece additionally comprises an antifoaming agent or a foam-inhibiting compound. This prevents any foaming, which may reduce the cleaning effect, which foaming can arise in particular in the decomposition of the proteins, in particular by proteases.

Preferably the liquid mixture used in step C for disinfecting the handpieces comprises water and an oxidant with at least one peroxide compound. Preferably organic peroxide compounds, for example perfruit acid or peracetic acid, are used, but it is also possible, in addition to or instead of the organic peroxide compounds, to use inorganic peroxide compounds, for example hydrogen peroxide. A particularly preferred oxidant is, in particular, perbenzoic acid, which is not as aggressive as many other oxidants, but nevertheless achieves the desired results and in particular the described combinatorial effects. Furthermore, it has been shown that, in particular, organic peroxides “react” particularly strongly to the conditioning caused by the enzymatic cleaning agent and therefore show particularly good combinatorial cleaning- and disinfecting effects.

Step B of the rinsing of the handpiece with a liquid mixture that also comprises an enzymatic cleaning agent preferably takes place in a temperature range of 50° C. to 65° C., wherein experiments have shown that optimal results are achieved in a temperature range of 55° C.±2° C.

Similarly, for disinfecting with a liquid mixture that comprises water and an oxidant, a preferred temperature range of 50° C. to 65° C. is selected, wherein experiments have shown that a temperature range of 62° C.±2° C. provides optimal results relating to conditioning as a result of rinsing, and relating to the use of conditioning by the disinfecting process.

For pre-rinsing the handpiece with a pre-rinsing liquid, in particular with water, as mentioned above preferably with mains water and at a corresponding mains water temperature, preferably the available pressure of the mains water is also used, in particular in a range from 2 to 6 bar, in particular 3 to 4 bar.

For step B and rinsing with a liquid mixture that comprises water and an enzymatic cleaning agent, preferably pressures of between 1 bar and 1.5 bar are used, wherein it has been found that optimum results are achieved at approximately 1.1 bar. A pressure of approximately 1.1 bar has been shown to be preferable in particular because it represents an optimal value in relation to the cleaning effect on the one hand, and to water consumption on the other hand; in other words, the pressure is sufficient for a very good cleaning effect to be achieved, while nevertheless at the same time being relatively low so as to also keep water consumption relatively low. Equal pressures are preferably used for disinfecting the handpiece with water and an oxidant; here again, experiments have shown that a pressure of approximately 1.1 bar leads to optimum results.

Preferably, the method according to the invention is supplemented by additional method steps, which can be carried out before or after the above-mentioned steps A, B and C, wherein it is furthermore possible to insert intermediate steps.

In a particularly preferred embodiment, between step A and step B an additional step A1 is inserted, in which the handpiece is rinsed with a liquid mixture that comprises water and a cleaning agent, wherein preferred temperatures of 30° C. to 40° C., in particular approximately 35° C., are used, wherein preferably in step A pre-rinsing of the handpiece at tap water temperature, approximately 15° C. to 20° C., is carried out.

This step-by-step increase in the temperature results in a particularly good cleaning performance and only insignificantly prolongs the entire treatment duration of the handpiece or handpieces.

In a further special method between step B and step C a further method step B1 is introduced which involves intermediate rinsing with water, wherein the water contains no additives, such as for example an enzymatic cleaning agent or an oxidant or some other cleaning agent. Preferably, this intermediate rinsing is carried out at a temperature of 60° C. to 70° C.

In a further preferred method, step C is followed by a re-rinsing step that is designated as step C1, wherein again water is used, preferably without any additives whatsoever. The temperatures of the re-rinsing step are 70° C. at most, but preferably below 60° C.; they can drop during this step so as to also slowly reduce the temperature of the handpiece itself.

Preferably, the method further comprises a drying step using warm air, step D, wherein preferred temperatures are between 80° C. and 95° C. and in particular in the range around approximately 90° C. In another preferred method, in step D only air is supplied without this air having been heated specially, wherein it is then possible, for the drying step, to use the residual warmth of the handpiece due to the preceding cleaning steps. This also provides an advantage in that the handpiece is cooled already during the drying step and can thus be quickly reused.

Furthermore, the method can comprise an additional step E, in which parts of the handpiece are supplied with a lubricant. In this way, in particular, movable parts of the handpieces are particularly maintained, which increases the service life of the handpieces and makes trouble-free working possible.

According to an embodiment of the method according to the invention, in at least one of the above-mentioned steps some compressed air is supplied at least partly. Preferably compressed air is supplied to the liquid stream in pulsed form, which provides in particular an advantage in that the mechanical effect of cleaning is improved during the individual steps. The pressure pulses can, for example, be carried out at a frequency of 0.5 Hz to 2 Hz and at a pressure ranging from 1 bar to 1.1 bar. The pressure pulses at the preferred frequency and at the above-mentioned pressures ensure that a pulsating movement is achieved, wherein the above-mentioned relatively low pressures are already sufficient, while contrary to expectations, higher pressures do not result in significant improvements of the cleaning results.

According to an aspect that in itself involves an inventive step, the individual method steps are carried out in a continuous-flow process, wherein water is continuously supplied as a carrier medium, for pre-rinsing, rinsing and disinfecting the handpiece to be cleaned, and water is also continuously removed, wherein the following are supplied to the carrier medium water: the cleaning agent during rinsing, according to claim 1 preferably the enzymatic cleaning agent, and the disinfectant during disinfecting, according to claim 1 preferably the oxidant; before the carrier medium acts on the handpiece to be cleaned.

This continuous-flow principle provides, in particular, an advantage in that the handpiece or handpieces to be cleaned do not have to remain in a water bath, and consequently no renewed contamination can occur, which provides an advantage in particular also on the device-side in that no liquid-proof or pressure-proof containers in the device are required. Furthermore, apart from the storage containers for the cleaning liquid, for the disinfectant and, if applicable, for the lubricant, no further containers are required. Moreover, such a system does not require a collection chamber for collecting the waste waters, because said waste waters are also continuously removed.

Particularly preferably it is also ensured that no circulation of the media takes place, and thus the media are used once only, which also ensures that no impurities that have already been removed can reach the handpieces again. This makes it possible to implement a cleaning method that meets extremely stringent requirements.

The invention further relates to a device for carrying out a method as described above, wherein the device comprises a receiving device for receiving or holding at least one medical handpiece; a reservoir for an enzymatic cleaning agent; a reservoir for an oxidant; a reservoir for water or a connection to a water supply; a control or dosing device; and a device for supplying water, enzymatic cleaning agent and oxidant to the control or dosing device; as well as a device for supplying the media used, either individually or in mixed form; and a heater.

The heater is preferably a flow heater, which also supports the above-described continuous-flow process in the best possible manner.

Preferably, the device further comprises a compressed-air reservoir or a connection to a compressed-air supply.

Preferably, the device comprises at least one connection element for supplying the liquids and/or the air to the interior of the handpiece, of which there is at least one, wherein it is further preferred that the device comprises a supply device, for example nozzles, for supplying liquid and/or air to exterior regions of the handpiece for exterior cleaning. Furthermore, the device comprises a discharge device that is also suitable for continuously removing the liquid used.

A particularly preferred embodiment of the device further comprises a device for the provision of ultrasound, in particular for supporting disinfecting or sterilising the exterior regions of the handpiece or of the handpieces. Furthermore, preferably spraying device for spraying or atomizing the lubricant can be provided, wherein the spraying device preferably operates with compressed air.

The device can be designed such that only one handpiece can be inserted and cleaned; however, devices are preferred in which at the same time several handpieces, for example three handpieces, can be inserted and cleaned.

With concurrent insertion of several handpieces, the method according to the invention and the device according to the invention can be designed such that all the handpieces are cleaned at the same time, i.e. that all the method-related steps are carried out simultaneously for all the inserted handpieces; however, it is particularly preferred that the individual method-related steps are carried out consecutively, however for each method-related step only for all the inserted handpieces so that at least as far as the user is concerned, quasi-simultaneous cleaning and disinfecting or treatment of the handpieces is carried out.

These and further characteristics and advantages of the invention will be further clarified with reference to the enclosed drawings:

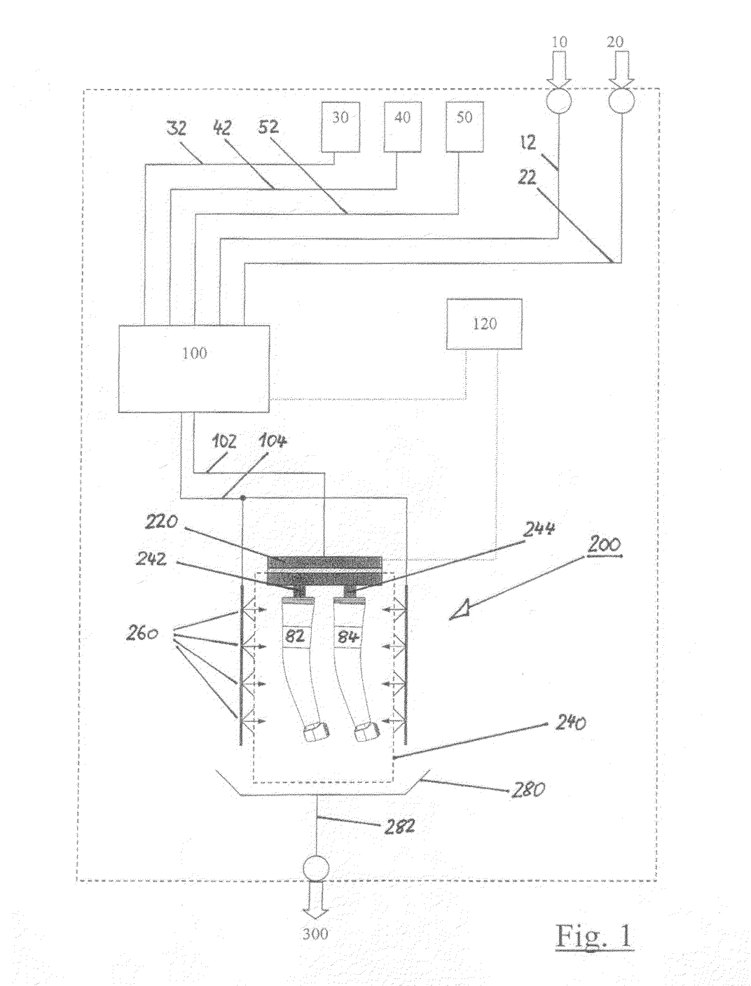

FIG. 1 diagrammatically shows an embodiment of a device according to the invention for implementing a method according to the invention;

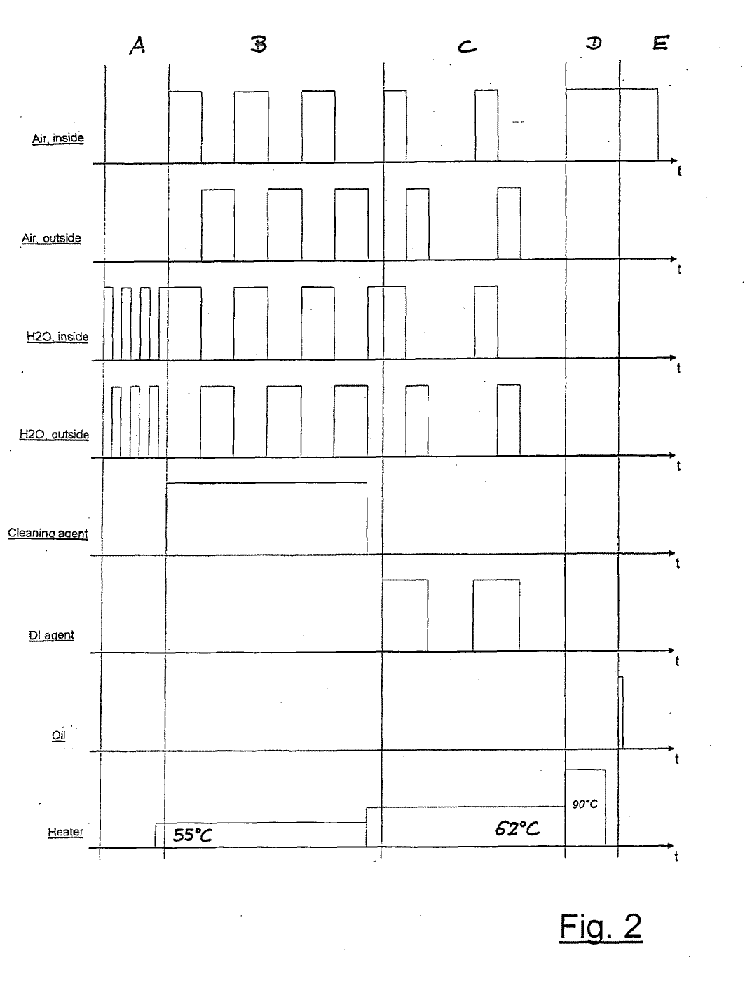

FIG. 2 in an exemplary manner shows a possible embodiment of the method according to the invention, with the individual method-related steps in time sequence.

FIG. 1 diagrammatically shows an embodiment of a device according to the invention for implementing a method according to the invention. The device comprises a reservoir 30 for a lubricant, in particular oil, a reservoir 40 for an enzymatic cleaning agent and a reservoir 50 for an oxidant. Furthermore, the device comprises a connection 10 for a water supply, in the present case a mains water supply, and a connection 20 for a compressed-air supply.

The connections 10 and 20 as well as the reservoirs 30, 40 and 50 are connected to a control or dosing device 100 by way of lines 12, 22, 32, 42, and 52. The control or dosing device 100 is controlled by a computer device 120.

The control or dosing device 100 comprises a valve that can make possible or interrupt the through-flow of water, or that can control or regulate the quantity of water flowing through the line 12. The control or dosing device 100 further comprises a second valve that can make possible or interrupt the through-flow of air through the line 22, or that can control or regulate the quantity of air flowing through.

The control or dosing device further comprises a total of three pump devices, wherein in each case one pump device is provided for conveying the liquids from the reservoirs 30, 40 and 50. The pumps are controlled by the control or dosing device 100 and the computer 120, so that their performance and thus their flow rate is adjustable.

In the control or dosing device 100 the lines 42 and 52 for the cleaning agent and for the disinfectant lead into the line 12 for the water supply, wherein, preferably in the inflow region, mixing chambers are provided. In this way, in particular the continuous-flow process is made possible, wherein water can preferably be supplied continuously through the line 12, the control or dosing device 100 and the line 102 or 104 onto the handpieces or into the handpieces, wherein if required the cleaning agent and/or the disinfectant are/is supplied.

One line 102 connects the control or dosing device 100 to a media transfer block 220, wherein the media that are supplied to the control or dosing device through the lines 12, 22, 32, 42 and 52 can be brought together and can be onward-conveyed to the media transfer block 220.

The handpieces 82 and 84 to be cleaned can be connected to the media transfer block 220 by way of connection devices or projections 242 and 244. This can take place directly, however it is also possible, as is the case in the embodiment shown, for a cassette 240 to be provided, which comprises the projections 242 and 244, so that the handpieces 82 and 84 can be connected to the projections 242 and 244 of the cassette 240, after which the entire cassette 240 is then connected to the media transfer block 220.

In the media transfer block 220 in this particularly preferred embodiment, once again, mixing chambers are provided; however, it is also possible to do without these mixing chambers, after mixing chambers have already been provided in the control or dosing device.

To complete the picture it should be pointed out that it is also possible for some or all the lines 12, 22, 32, 42 and 52 to continue into the media transfer block 220, wherein the supply of media, as described above, is regulated by the control or dosing device 100, in which case mixing chambers are provided exclusively in the media transfer block 220. In a particularly preferred embodiment, the control or dosing device 100 and the media transfer block 220 are designed as an integral device or in a single part. This results in a particularly compact overall system.

An additional line 104 conveys the media, which are led through the lines 12, 22, 42 and 52 to the control or dosing device 100, to several nozzle devices 260 that for exterior treatment of the handpieces 82, 84 spray media onto the exterior of the handpieces. Exterior treatment with the use of a lubricant is not required, therefore the line 32 does not lead into the line 104. The nozzles 260 can be provided as part of the cleaning device and in cases where a cassette 240 is provided can reach through openings in the cassette into the interior of the cassette. However, it is also possible for the nozzles to be designed as part of the cassette.

For the purpose of lubrication, lubricant is conveyed from the container 30 through the lines 32 and 102 into the projections 242 and 244. In a preferred embodiment it is possible, in particular, for the line carrying the lubricant to be routed into the media transfer block so as to be separate from the line or the lines for the other media. Preferably, however, in the control or dosing device 100 at least one branch of the compressed-air line 22 leads into the lubricant line so that the lubricant can be atomised.

The media emanating from the handpieces 82 and 84, as well as the media used for exterior cleaning, flow into a collecting device 280, which preferably comprises a funnel, from which collecting device 280 the media is removed by way of a discharge line 282 and a discharge device 300, preferably by way of a pump. Except for the reservoirs 30, 40 and 50 the cleaning device shown in the figure comprises no liquid-proof or pressure-proof containers in which the liquids used for cleaning have to be contained or held, and in which particles, lubricant and micro-organisms could be deposited. Nor is there any multiple use or return of liquids, so that advantageously any danger of contamination or re-contamination of handpieces by the cleaning device itself is prevented.

FIG. 2 diagrammatically shows a preferred overall process in which the supply of the individual media is shown in a sequential manner.

The particular embodiment of the method according to the invention, which is shown in the diagram, comprises a total of five steps, namely a pre-cleaning or a pre-rinsing step A, a cleaning step B, a disinfection step C, a drying step D and a lubrication/blow-out step E.

In the pre-rinsing step A only water is supplied, wherein water is both fed through the interior of the handpieces and sprayed onto the exterior of the handpieces, with this process taking place in an alternating manner.

In the subsequent cleaning step B both compressed air and water are supplied, alternately again into the interior of the handpiece and onto the exterior region of the handpiece or handpieces, wherein the enzymatic cleaning agent is continuously supplied. In this step the supplied media is also additionally heated up; in the embodiment shown to about 55° C.

From a method-related point of view the subsequent disinfection step C is similar to the above-described step B, wherein instead of the enzymatic cleaner an oxidant is supplied. The disinfection step C is carried out twice, with a short interruption in between, wherein in the method shown a preferred temperature of approximately 62° C. is set.

Subsequently a drying step D is carried out, in which compressed air is heated to approximately 90° C. and is fed through the interior region of the handpiece or of the handpieces.

In a subsequent lubrication- and blow-out step E by way of compressed air a lubricant, in particular oil, is supplied to the interior of the handpiece, wherein oil is supplied only for a short period of time, while blowing out takes place for an extended period of time, as is clearly shown in FIG. 2.

The individually shown method-related steps can vary in length. In step A the individual blocks of supplying water both to the interior region and to the exterior region preferably last 3 to 5 seconds; while the individual blocks of supplying air and water in step B preferably last approximately 5 to 20 seconds.

In a preferred embodiment the individual blocks in the disinfection step C last approximately 20 to 40 seconds, while the drying step D preferably lasts approximately 10 to 20 seconds. It should be pointed out that step C can also be carried out for a longer period of time, which then leads to better results right up to sterilisation. In step D it is, furthermore, possible to carry it out in two parts, wherein in a first step air heating is switched on, as shown in FIG. 2, wherein this first step lasts approximately 10 to 15 seconds, while in a second step the air heating is switched off, with blowing-out preferably lasting for a further 5 to 30 seconds.

In step E the lubricant is dosed-in only for a very short period of time, while the step of blowing-out preferably lasts 10 to 20 seconds.

With a method according to the invention, as shown in a particular embodiment in FIG. 2, the entire method can therefore be completed with outstanding results and yet in a very short time. The overall cycle, for example in the case of three handpieces, takes a period of time of between 8 and 12 minutes.

The features disclosed in the above description, the claims and the drawing can be significant, both individually and in any combination, in implementing the invention in its various embodiments.

1. A method for preparing a medical instrument (82, 84), wherein the method comprises the following steps:
A) pre-rinsing the instrument (82, 84) with a pre-rinsing liquid whose temperature is below the coagulation temperature of protein;
B) rinsing the instrument (82, 84) with a liquid mixture that comprises water and an enzymatic cleaning agent, wherein the liquid mixture has a temperature of 40° C. to 70° C.;
C) disinfecting the instrument (82, 84) with a liquid mixture that comprises water and an oxidant, wherein the liquid mixture has a minimum temperature of 50° C.

2. The method according to claim 1, characterised in that in all the steps the liquids are fed in a continuous-flow process through the instrument (82, 84).

3. The method according to claim 1, characterised in that the pre-rinsing liquid used in step A is water or comprises water and a cleaning agent.

4. The method according to claim 1, characterised in that the liquid mixture used in step B for rinsing the instrument (82, 84) comprises at least one enzyme group.

5. The method according to claim 1, characterised in that the oxidant comprises at least one peroxide compound.

6. A method for preparing a medical instrument (82, 84), wherein the method comprises the following steps:
A) pre-rinsing the instrument (82, 84) with a pre-rinsing liquid;
B) rinsing the instrument (82, 84) with a liquid mixture that comprises water and a cleaning agent;
C) disinfecting the instrument (82, 84) with a liquid mixture that comprises water;
wherein the individual method steps are carried out continuously, wherein water is continuously supplied as a carrier medium, for pre-rinsing, rinsing and disinfection the instrument (82, 84) to be cleaned, and water is continuously removed.

7. The method according to claim 6, wherein, during step B, rinsing, an enzymatic cleaning agent is supplied to the carrier medium water, and wherein during step C, disinfection, an oxidant is supplied to the carrier medium water, before the carrier medium acts on the instrument (82, 84) to be cleaned.

8. The method according to claim 6, characterised in that the pre-rinsing liquid used in step A is water or comprises water and a cleaning agent.

9. The method according to claim 6, characterised in that the liquid mixture used in step B for rinsing the instrument (82, 84) comprises at least one enzyme group.

10. The method according to claim 6, characterised in that the enzyme group, of which there is at least one, comprises proteases, lipases and/or amylases.

11. The method according to claim 6, characterised in that the liquid mixture used in step B for rinsing the instrument (82, 84) additionally comprises an antifoaming agent or a foam-inhibiting compound.

12. The method according to claim 6, characterised in that the oxidant comprises at least one peroxide compound.

13. The method according to claim 6, characterised in that the oxidant comprises perbenzoic acid.

14. The method according to claim 6, characterised in that step A is carried out with a pre-rinsing liquid with a temperature of 15° C. to 20° C., wherein, furthermore, between step A and step B an additional method step A1 is carried out in which the instrument (82, 84) is rinsed with a liquid mixture that comprises water and a cleaning agent, with the temperature of said liquid mixture being between 30° C. and 40° C.

15. The method according to claim 6, characterised in that between step B and step C a further method step B1 is carried out, which step is an intermediate rinsing step and in which the instrument (82, 84) is rinsed with water in a temperature range of 60° C. to 70° C.

16. The method according to claim 6, characterised in that step C is followed by a re-rinsing step C1 in which the instrument is rinsed with water at a temperature of 70° C. at maximum.

17. The method according to claim 6, characterised in that the method comprises an additional drying step D in which the instrument (82, 84) is treated with warm air.

18. The method according to claim 6, characterised in that the method involves an additional method step E in which the instrument (82, 84) is supplied with a lubricant.

19. The method according to claim 6, characterised in that in one of the above-mentioned steps compressed air is supplied at least partly.

20. A device for implementing a method according to claim 1, wherein the device comprises:
a receiving device (242, 244) for receiving at least one medical instrument (82, 84);
a reservoir (40) for a cleaning agent;
a reservoir for water or a connection device (10) for connection to a water supply;
a control or dosing device (100);
a device for supplying water, cleaning agent and/or oxidant to the control or dosing device (100);
a device for supplying media to and/or into the at least one medical instrument (82, 84); and
a heater.

21. The device according to claim 20, additionally comprising a reservoir (50) for an oxidant.

22. The device according to claim 20, comprising a connection element (242, 244) for supplying the media to the interior of the instrument (82, 84).

23. The device according to claim 20, further comprising a supply device (260) for supplying the media to an exterior region of the instrument (82, 84).

24. The device according to claim 20, further comprising a discharge device (280, 282, 300) for continuously removing the media.

25. A device, wherein the device comprises:
a receiving device (242, 244) for receiving at least one medical instrument (82, 84);
a reservoir (40) for a cleaning agent;
a reservoir for water or a connection device (10) for connection to a water supply;
a control or dosing device (100);
a device for supplying water, cleaning agent and/or oxidant to the control or dosing device (100);
a device for supplying media to and/or into the at least one medical instrument (82, 84); and
a heater.
